(19) United States
(12) Patent Application Publication
(10) Pub. No.: US 2009/0160843 A1
(43) Pub. Date: Jun. 25, 2009

(54) DISPLAY AND ELECTRONIC DEVICE USING THE SAME

(75) Inventors: LUNG DAI, Tu-Cheng (TW); ZHI-PENG MA, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., ShenZhen City (CN); HON HAI PRECISION INDUSTRY CO., LTD., Tu-Cheng (TW)

(21) Appl. No.: 12/171,252

(22) Filed: Jul. 10, 2008

(30) Foreign Application Priority Data
Dec. 21, 2007 (CN) 200710203333.4

(51) Int. Cl. G09G 5/00

(52) U.S. Cl. 345/214

(57) ABSTRACT

A display comprising: a display module for displaying video signals thereon, a backlight module for emitting light towards the display module, and a controller electrically coupled with the backlight module for providing a control signal to the backlight module for disabling or enabling the backlight module. At a first time point, preset by the controller, the control signal disables the backlight module. An electronic device using the display is also disclosed.

### BACKGROUND

1. Technical Field

The disclosed embodiments relate to electronic devices and, more particularly, to a display of an electronic device having an energy saving function for reducing power consumption.

2. Description of Related Art

With the rapid development of technologies, energy demands, such as electricity, have been rapidly increasing. It has been more and more important to reduce power consumption in today's society. Therefore, power consumption has become an important factor to judge the performance of electronic devices, such as televisions.

Some methods, such as reducing brightness of a reproduced image, can be used to reduce the power consumption for televisions and other display device. Manufacturers usually embed programs for users to adjust brightness.

However, these manufacturer's programs are limited in their usage and reducing power consumption should be a continuous and uninterrupted motion, other new methods and corresponding programs are still needed to be developed.

Therefore, a need exists for an electronic device resolving the above problem in the industry.

### SUMMARY

A display comprising: a display module for displaying video signals thereon, a backlight module for emitting light towards the display module, and a controller electrically coupled with the backlight module for providing a control signal to the backlight module for disabling or enabling the backlight module. At a first time point, preset by the controller, the control signal disables the backlight module. An electronic device using the display is also disclosed.

Other advantages and novel features will become more apparent from the following detailed description of embodiments when taken in conjunction with the accompanying drawings.

### BRIEF DESCRIPTION OF THE DRAWINGS

FIG. 1 is a block diagram of hardware infrastructure of an electronic device in accordance with a first exemplary embodiment.

FIG. 2 is a block diagram of hardware infrastructure of an electronic device in accordance with a second exemplary embodiment.

### DETAILED DESCRIPTION

The disclosed embodiments involve in turning off the display function of an electronic device according to instructions inputted, so as to save energy. The following detailed descriptions of embodiments are made with reference to the attached drawings, in detail.

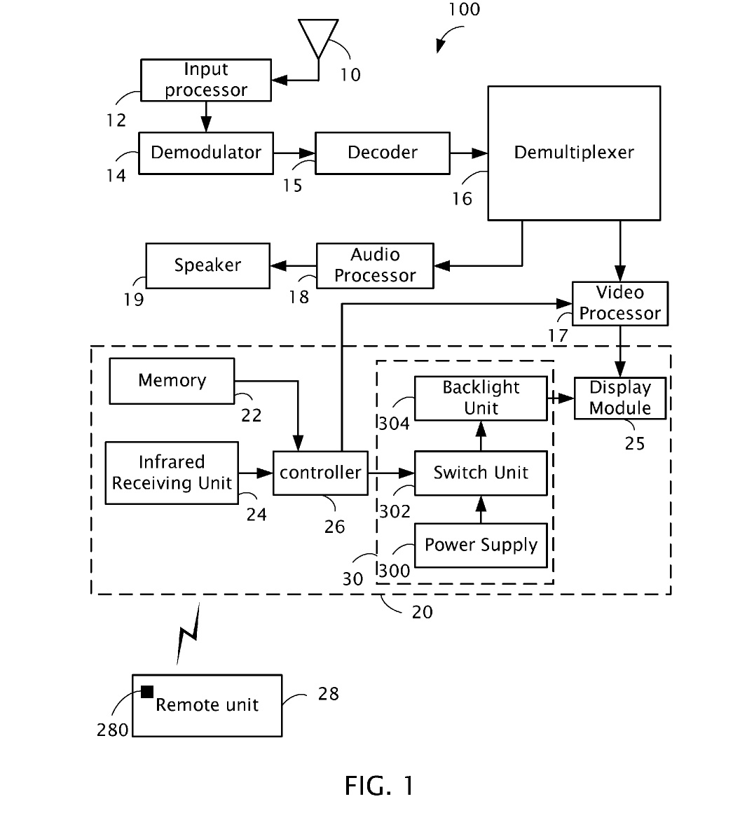

Referring to FIG. 1, a first embodiment in accordance with a present electronic device includes an antenna 10, an input processor 12, a demodulator 14, a decoder 15, a demultiplexer 16, a video processor 17, an audio processor 18, a speaker 19, a display 20, and a remote unit 28. The display 20 includes a memory 22, a receiving unit 24, a display module 25, a controller 26, and a backlight module 30 for emitting light towards the display module 25. In this embodiment, the electronic device 100 is a television.

The antenna 10 is connected to the input processor 12, the input processor 12 is connected to the demodulator 14, and the demodulator 14 is connected to the decoder 15. The demultiplexer 16 is connected to the decoder 15, the video processor 17, and the audio processor 18. The audio processor 18 is connected to the speaker 19. The display module 25 is connected to the video processor 17 and the backlight module 30. The controller 26 is connected to the video processor 17, the memory 22, the receiving unit 24, and the backlight module 30.

The antenna 10 receives broadcast signals, and the broadcast signals are processed by the input processor 12 to generate resultant signals. The resultant signals are further demodulated and decoded by the demodulator 14 and the decoder 15 respectively and successively, so as to generate a transport datastream. The transport datastream is demultiplexed into video and audio data by the demultiplexer 16.

The video processor 17 processes the video data, and outputs video signals to the display module 25. The backlight module 30 emits the light towards the display module 25, the display module 25 allows some of the light to pass through according to the video signals, so as to display the video signals.

Similarly, the audio processor 18 processes the audio data, and outputs audio signals, synchronized with the associated video signals, to the speaker 19 for audio reproduction.

The memory 22 stores a timing program. In order to preset a first time point T_{f} and a second time point Tₛ, the remote unit 28 generates timing signals according to instructions from users, and wirelessly sends the timing signals to the receiving unit 24. The controller 26 calls the timing program to preset the first time point T_{f} and the second time point Tₛ, for example 12:00 and 13:00, according to the timing signals. The first time point T_{f} could be set to disable the backlight module 30 and the second time point Tₛ could be set to enable the backlight module 30. The first time point T_{f} and the second time point Tₛ are stored in the memory 22.

At the first time point T_{f}, a first control signal is generated by the controller 26 for disabling the backlight module 30. Thus the backlight module 30 does not emit the light, and the audio processor 18 still outputs audio signals to the speaker 19 for audio reproduction. Therefore, users can listen to the audio output, without the associated video output, of a television (TV), and the power consumption of the electronic device 100 is reduced. In another embodiment, at the first time point, the first control signal disables both the video processor 17 and the backlight module 30. Thus the backlight module 30 does not emit the light, and the video processor 17 does not output the video signals to the display module 25, but the audio processor 18 still outputs audio signals to the speaker 19. Therefore, users can listen to the audio output, without the associated video output, of the TV, and the power consumption of the electronic device 100 is further reduced.

At the second time point Tₛ, the controller 26 generates a second control signal for enabling the backlight module 30. Thus the backlight module 30 emits the light, and the video processor 17 still outputs the video signals to the display module 25, for wake up purpose. Therefore the time required for the display module 25 to display the video signals is reduced, as compared to the video processor 17 being disabled. In another embodiment, as mentioned above, at the second time point Tₛ, the second control signal enables both the video processor 17 and the backlight module 30.

The remote unit 28 includes a control key 280. The control key 280 is used to manually enable the backlight module 30 or the video processor 17. When the control key 280 is pressed, the remote unit 28 generates a command. The receiving unit 24 receives the command, and the controller 26 generates a third control signal according to the command. The third control signal enables the backlight module 30 which has been disabled. In another embodiment, as mentioned above, the third control signal enables both the backlight module 30 and the video processor 17 which have been disabled.

The backlight module 30 includes a power supply 300, a switch unit 302, and a backlight unit 304. The controller 26 is connected to the switch unit 302. The switch unit 302 is connected between the power supply 300 and the backlight unit 304. The backlight unit 304 is connected to the display module 25.

The power supply 300 provides power to the backlight unit 304 via the switch unit 302. The backlight unit 304 receives the power from the power supply 300, and emits the light towards the display module 25. The display module 25 receives the video signals from the video processor 17 and allows some of the light to pass through according to the video signals, so as to display the video signals.

The switch unit 302 establishes and cuts off an electronic connection between the power supply 300 and the backlight unit 304. The controller 26 controls the switching action of the switch unit 302. In detail, when the electronic device 100 is powered on, the switch unit 302 is turned on, and the switch unit 302 electrically connects the power supply 300 to the backlight unit 304. When the switch unit 302 is turned off, the switch unit 302 cuts off the electronic connection between the power supply 300 and the backlight unit 304.

At the first time point T_{f}, the controller 26 generates the first control signal for turning off the switch unit 302. Therefore the backlight unit 304 does not receive the power from the power supply 16 and does not emit the light. In another embodiment, the first control signal turns off the switch unit 302 and disables the video processor 17. Therefore the backlight unit 304 does not emit light, and the video processor 17 does not output the video signals to the display module 25.

At the second time point Tₛ, the controller 26 generates the second control signal for turning on the switch unit 302. Thus, the backlight unit 304 receives the power from the power supply 16 and emits the light. In another embodiment, the second control signal turns on switch unit 302 and enables the video processor 17. Thus the video processor 17 outputs the video signals to the display module 25, and the backlight unit 304 receives the power from the power supply 16 and emits the light.

When the control key 280 is pressed, the remote unit 28 generates the command. The receiving unit 24 receives the command, and the controller 26 generates the third control signal according to the command. The third control signal turns on the switch unit 302 which has been turned off. In another embodiment, the third control signal enables the video processor 17 which has been disabled and turns on the switch unit 302 which has been turned off. Therefore, the display module 25 displays the video signals.

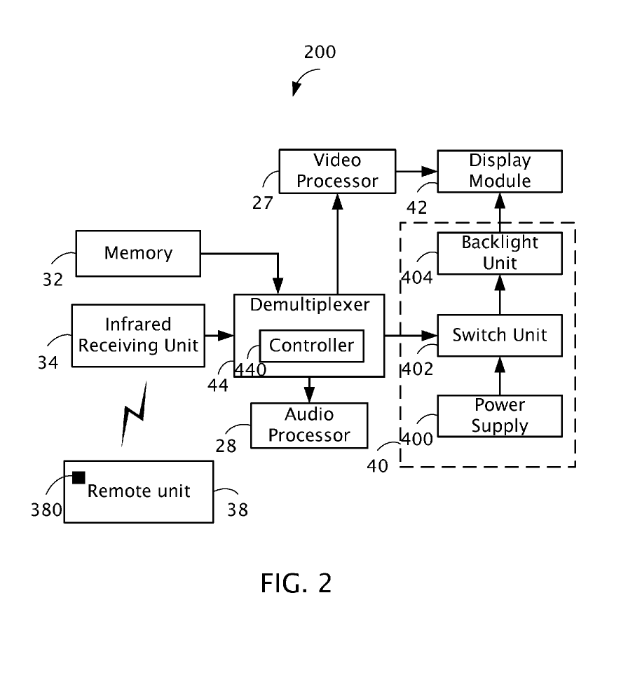

Referring to FIG. 2, a second embodiment in accordance with present electronic device includes a video processor 27, an audio processor 28, a memory 32, an receiving unit 34, a remote unit 38, a backlight module 40, a display module 42, a demultiplexer 44. The backlight module 40 includes a power supply 400, a switch unit 402, and a backlight unit 404.

The demultiplexer 44 includes a controller 440. The video processor 27, the audio processor 28, the memory 32, the receiving unit 34, the remote unit 38, the backlight module 40, the display module 42, and the controller 440 performs the same function as the video processor 17, the audio processor 18, the memory 22, the receiving unit 24, the remote unit 28, the backlight module 30, the display module 25, and the controller 26 shown in FIG. 1 respectively.

The power supply 400 provides the power to the backlight unit 404 via the switch unit 402. The backlight unit 404 receives the power from the power supply 400, and emits light towards the display module 42. The display module 42 receives the video signals from the video processor 27 and allows some of the light to pass through according to the video signals, so as to display the video signals.

At the first time point T_{f}, the controller 440 generates the first control signal for turning off the switch unit 402. In another embodiment, the first control signal turns off the switch unit 402 and disables the video processor 27. Thus, the power consumption of the electronic device 200 is reduced.

At the second time point, the controller 440 generates the second control signal for turning on the switch unit 402. In another embodiment, the second control signal turns on the switch unit 402 and enables the video processor 27.

The remote unit 38 includes a control key 380. When the control key 380 is pressed, the controller 440 generates the third control signal. The third control signal turns on the switch unit 402 that has been turned off. In another embodiment, the third control signal enables the video processor 27 that has been disabled and turns on the switch unit 402 that has been turned off. Therefore, the video processor 27 outputs the video signals to the display module 42, the backlight unit 404 emits the light, and the display module 42 displays the video signals.

Alternative embodiments will become apparent to those skilled in the art to which the present invention pertains without departing from the spirit and scope. Accordingly, the present invention should be deemed not to be limited to the above detailed description, but rather by the claims that follow.

What is claimed is:

1. A display comprising:
a display module for displaying video signals thereon;
a backlight module for emitting light towards the display module; and
a controller electrically coupled with the backlight module for providing a control signal to the backlight module for disabling or enabling the backlight module;
wherein at a first time point, preset by the controller, the control signal disables the backlight module.

2. The display as claimed in claim 1, wherein at a second time point, preset by the controller, the control signal enables the backlight module.

3. The display as claimed in claim 1, further comprising a memory for storing a timing program, a receiving unit for receiving timing signals from a remote unit, wherein the controller calls the timing program to preset the first time point and a second time point according to the timing signals, and the first time point and the second time point are stored in the memory.

4. The display as claimed in claim 3, wherein the remote unit comprises a control key, when the control key is pressed, the control signal enables the backlight module which has been disabled.

5. The display as claimed in claim 3, wherein the backlight module comprises a power supply for supplying power, a backlight unit for receiving the power and emitting the light, and a switch unit for establishing and cutting off an electronic connection between the power supply and the backlight unit.

6. The display as claimed in claim 5, wherein at the first time point, the control signal turns off the switch unit.

7. The display as claimed in claim 6, wherein at the second time point, the control signal turns on the switch unit.

8. The display as claimed in claim 6, wherein the remote unit comprises a control key, when the control key is pressed, the control signal turns on the switch unit which has been turned off.

9. An electronic device comprising:
a display module for displaying video signals;
a backlight module for emitting light towards the display module;
a video processor for outputting the video signals to be displayed for the display module; and
a controller coupled with the backlight module for providing a control signal to the backlight module for disabling or enabling the backlight module;
wherein at a first time point, preset by the controller, the control signal disables the backlight module.

10. The electronic device as claimed in claim 9, wherein a second time point is preset by the controller, at the second time point the control signal enables the backlight module.

11. The electronic device as claimed in claim 9, further comprising a memory for storing a timing program, a receiving unit for receiving timing signals from a remote unit, wherein the controller calls the timing program to preset the first time point and a second time point according to the timing signals, and the first time point and the second time point are stored in the memory.

12. The electronic device as claimed in claim 1, wherein the remote unit comprises a control key, when the control key is pressed, the control signal enables the backlight module which has been disabled.

13. The electronic device as claimed in claim 11, wherein at the first time point, the control signal also disables the video processor.

14. The electronic device as claimed in claim 13, wherein at the second time point, the control signal enables the backlight module and the video processor.

15. The electronic device as claimed in claim 13, wherein the remote unit comprises a control key, when the control key is pressed, the control signal enables the backlight module and the video processor which have been disabled.

16. The electronic device as claimed in claim 1, wherein the backlight module comprises a power supply for supplying power, a backlight unit for receiving the power and emitting the light, and a switch unit for establishing and cutting off an electronic connection between the power supply and the backlight unit.

17. The electronic device as claimed in claim 16, wherein at the first time point, the control signal turns off the switch unit.

18. The electronic device as claimed in claim 17, wherein at the second time point, the control signal turns on the switch unit.

19. The electronic device as claimed in claim 17, wherein the remote unit comprises a control key, when the control key is pressed, the control signal turns on the switch unit which has been turned off.

20. An electronic device comprising:
a display module configured for displaying video signals;
a backlight module configured for emitting light towards the display module;
a video processor configured for outputting the video signals to be displayed for the display module; and
a controller coupled with the backlight module and the video processor for providing a control signal to the backlight module and the video processor for disabling or enabling the backlight module and the video processor;
wherein at a first time point, preset by the controller, the control signal disables the backlight module and the video processor.
